(19) United States
(12) Patent Application Publication
(10) Pub. No.: US 2003/0116630 A1
(43) Pub. Date: Jun. 26, 2003

(54) Encrypted biometric encoded security documents

(75) Inventors: Martin Carey, Pully (CH); Pierre-Yves Anderegg, Lausanne (CH); Hans-Jorg Hirsch, Preverenges (CH)

Correspondence Address: John Moetteli, BUGNION S.A., Case postale 375, GENEVA, 1211 GENEVA 12, CH

(73) Assignee: KBA-Giori S.A., Lausanne (CH)

(21) Appl. No.: 10/270,614

(22) Filed: Oct. 16, 2002

Related U.S. Application Data
(63) Continuation-in-part of application No. 10/166,208, filed on Jun. 10, 2002.
(60) Provisional application No. 60/343,096, filed on Dec. 21, 2001.
(60) Provisional application No. 60/357,595, filed on Feb. 15, 2002.

(51) Int. Cl. G06K 7/10; G06K 9/18

(52) U.S. Cl. 235/462.09

(57) ABSTRACT

A data storage device is provided in which encoded binary machine-readable, digital hierarchical data may be stored. The data is represented by X-nary characters in a matrix. Two different hierarchical 2-D barcodes may be superimposed to increase the data storage capacity. The device is integrated in a system having a scanner, a identifying characteristic reader, a computer, a comparator, a connection device, and a display, all of which being managed by a computer operably connected therebetween. The scanner (a) reads a portable identification carrier onto which is encoded identifying characteristic data of at least one person; (b) sends such identification data to the computer for verification of authenticity of the carrier and (c) extracts a identifying characteristic of a certain identifying characteristic parameter from the identifying characteristic data encoded on the carrier. The identifying characteristic reader reads a same identifying characteristic parameter of the person purported to be identified by the carrier. The comparator compares the encoded identifying characteristic with the extracted identifying characteristic to authenticate the person associated with the carrier. The connection means, if the carrier and at least one person are authenticated, enables the computer to connect to a data storage device of travel permissions associated with that person or type of person. The display displays the user permissions to an authority to aid the authority in determining a disposition with regard to the person. A method of using a user permissions communication interface system is also disclosed.

### CROSS REFERENCE TO RELATED APPLICATIONS

This application is a continuation-in-part application of U.S. patent application Ser. No. 10/166,208, to Anderegg et al, filed Jun. 10, 2002, to which priority is claimed, along with provisional applications serial numbers 60/343,096, filed Dec. 21, 2001, and 60/357,595, filed Feb. 15, 2002 of the same title, the contents of which are incorporated by reference thereto.

### BACKGROUND OF THE INVENTION

This invention relates to security printing solutions, and, more particularly, to documents coded with high-data density, such as biometric information, for security purposes.

Smart cards have been used to store personal information and even biometric information about their owners to facilitate electronic transactions. For example, U.S. Pat. No. 6,219,439, the content of which is incorporated herein by reference, describes such a smart card. Here, information is stored on a chip embedded within the smart card.

Further, U.S. Pat. No. 6,219,439 describes a identifying characteristic authentication system using a smart card having stored physiological data of a user on a chip disposed therein, and a fingerprint scan (or retina scan, voice identification, saliva or other identifying characteristic data) for comparison against the stored data. The system is self-contained so that the comparison of the identifying characteristic data with the data stored on the chip is done immediately on board the reader without relying upon communications to or from an external source in order to authenticate the user. This arrangement also prevents communication with external sources prior to user authentication being confirmed, so as to prevent user data from being stolen or corrupted.

U.S. Pat. No. 6,101,477, the content of which is incorporated herein by reference, describes a smart card for travel-related use, such as for airline, hotel, rental car, and payment-related applications. Furthermore, memory space and security features within specific applications provide partnering organizations (e.g., airlines, hotel chains, and rental car agencies) the ability to construct custom and secure file structures.

Watermarks have been used for many years on currency and other articles in order to ensure authenticity. A system for watermarking documents is described in WO 00/07356, the content of which is incorporated by reference. Security documents (e.g. passports, currency, event tickets, and the like) are encoded to convey machine-readable multi-bit binary information (e.g. digital watermark), usually in a manner not alerting human viewers that such information is present. The documents incorporate overt or subliminal calibration patterns which when scanned (e.g. by a photocopier), the pattern facilitates detection of the encoded information notwithstanding possible sealing or rotation of the scan data. The calibration pattern can serve as a carrier for the watermark information, or the watermark can be encoded independently. A passport processing station responsive to such markings can use the decoded binary data to access a database having information concerning the passport holder. Some such apparatuses detect both the watermark data and the presence of a visible structure characteristic of a security document (e.g., a printed seal of the document's issuer). Nevertheless, no specific biometric data is described. Neither is the use of a data carrier in the form of a barcode described. Digital signatures or certificates are now often used to authenticate documents.

U.S. Pat. Nos. 5,912,974 and 6,131,120, the contents of which are incorporated herein by reference, describe other methods for the authentication of printed documents. In U.S. Pat. No. 5,912,974, segments of an image are associated with a set of rules and a public key for use in authentication.

In U.S. Pat. No. 6,131,120, an enterprise network operating on a wide area network (WAN), and having routers and servers, uses a master directory to determine access rights including the ability to access the WAN through the routers and the ability to access the server over the WAN.

Security, particularly at major airports has become a significant concern, especially since the tragic events of Sep. 11, 2001. No printable identification is currently available to positively identify a passenger with high reliability. No means is currently available to transmit such information securely and to associate that information with user specific permissions.

U.S. Pat. No. 5,291,560, the content of which is incorporated herein by reference, describes a personal identification system based on iris analysis. U.S. Pat. No. 5,363,453, the content of which is incorporated by reference, describes a personal identification system based on biometric fingerprint data. However, there is no encryption of the biometric information involved.

U.S. Pat. No. 4,972,476, the content of which is incorporated by reference, describes a counterfeit proof ID card having a scrambled facial image, in which the facial image is scrambled using a descrambling control code assigned to the proper user. However, only photographic data is used.

Despite the above efforts, no prior art methods are available for encoding encrypted identifying characteristic information in high data density on a printable substrate. No prior art methods are available for encoding identifying characteristic information of related persons on a single printable substrate. In addition, identifying characteristic data is becoming more and more detailed and thus requires either a significant amount of space to record, or, if space is not available (such as on a pocket or credit card size ID card), the amount of stored identifying characteristic data is limited or the resolution of the two dimensional representation must be extremely high.

What is needed therefore is a means of encoding high data-density identifying characteristic information in a printable form within a limited two-dimensional area. In addition, what is needed is a means of authenticating a plurality of data of one person and a plurality of data of multiple persons.

### SUMMARY OF THE INVENTION

A user permissions communication interface system is provided, having a scanner, an identifying characteristic reader, a computer, a comparator, a connection device, and a disposition device, all of which being managed by a computer operably connected therebetween. The scanner (a) reads a portable identification carrier onto which is encoded identifying characteristic data of at least one person in a matrix of X-nary bits; (b) the read identification data is then sent to the computer for verification of authenticity of the carrier and (c) an identifying characteristic of a certain identifying characteristic parameter is extracted from the identifying characteristic data encoded on the carrier. The identifying characteristic reader reads a same identifying characteristic parameter of the person purported to be identified by the carrier. The comparator compares the encoded identifying characteristic with the extracted identifying characteristic to authenticate the person associated with the carrier. The connection device, if said carrier and at least one person are authenticated, enables the computer to connect to a data storage device of user permissions associated with that person or type of person. The disposition device dispositions the person by, for example, displaying the user permissions to an authority to aid the authority in determining a disposition with regard to the at least one person or automatically generating a disposition action.

In another feature, a method of increasing the data storage capacity of a printed data storage device is provided. The method includes four steps. In a first step, data to be stored is divided into at least two categories of information. In a second step, such categories of information are optionally encrypted. In a third step, such information is encoded into a superimposable, differentiable information layer. Each layer of information is differentiated from other such layers through a specific characteristic in its representation in order to permit separation of the layers during a decoding process. In a fourth step, each differentiable layer of encoded information is superimposed over remaining layers. In a fifth step, the superimposed layers are printed on a printable substrate. The differentiation between layers may be obtained through a number of different means, including different color spectrums, light spectrums, or geometric modulation of information elements such as lines or symbols.

In another feature, a data storage medium is provided capable of storing a large amount of data on a two dimensional space.

In another feature, a method of using a user permissions communication interface system is provided.

In another feature, a portable identification carrier reading and decoding device is provided which reads and decodes an encoded, encrypted identifying characteristic on a portable identification carrier.

An object of the invention is to provide global interoperability through use of printed document format not unlike existing documents.

Another object of the invention is to provide improved document security through information encryption.

Another object of the invention is to provide an article that enables positive identification (verification that the presenter of the document is the rightful holder) through the use of highly reliable identifying characteristic information, such as biometric fingerprint, retina scan, voice identification, saliva, iris recognition, facial recognition, or other identifying characteristic data. A functional identifying characteristic identity system requires the storage of a substantial amount of machine-readable digital data.

Another object of the invention is a printed storage device for digital data, such as e.g. a hierarchical barcode, with increased data capacity in a given space and at a given image resolution.

Another object of the invention is to provide a decoding method for the above-mentioned printed storage device.

Another object of the invention is to provide a technology that is applicable on several products including passports, visas, and other travel or identity documents.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic diagram of the system of the invention.

FIG. 2 is a plan view of an identification carrier of the invention.

FIGS. 3A-3C are plan views of equivalent binary 2-D barcodes of the prior art.

FIG. 4 is a plan view of the hierarchical 2-D barcode of the invention.

FIG. 5 is a plan view of an alternate embodiment of the hierarchical 2-D barcode of the invention.

FIG. 6 is a plan view of an alternate embodiment of an identification carrier of the invention having a color X-nary hierarchical barcode.

FIG. 7 is a plan view of an alternate identification carrier of the invention with sufficient data carrying capacity to include biometric data of an entire family.

FIG. 8 is a flow chart of a decoding method of the invention.

FIG. 9 is a flow chart of the method of the invention.

### DETAILED DESCRIPTION OF THE PREFERRED EMBODIMENT

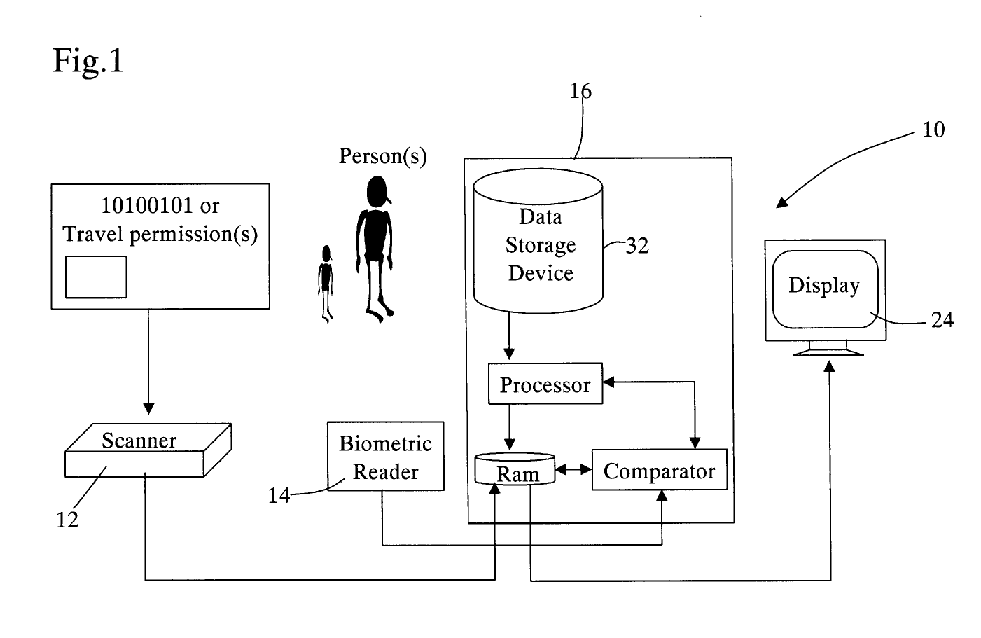

Referring now to FIG. 1, a user permissions communication interface system 10 is provided, having a scanner 12, an identifying characteristic reader 14 reading identifying characteristic data 15, a computer 16, a comparator 20, connections 22, and a display 24, all of which being managed by a computer 16 operably connected therebetween by I/O data lines, whether wireless (e.g., “BLUETOOTH”™) or network, by serial, parallel, UBS, pcs cable, or other connection. Identifying characteristics are characteristics of a person, including biometrics, legal status, permissions, education, licenses, familial relations, health information, or any other data associated with the individual. Biometric data 15 includes any data representative of a biological structure unique to an individual excepting conventional photographic data. Identifying characteristics are usually rendered in binary form. So too is biometric information, which generally defines certain reference points measured from the biometric structure. According to the method of the invention, such data is stored in X-nary form, meaning in a form relatively independent of the base of the system.

Examples of biometric data include iris scan data, retinal scan data, voice identification, saliva, fingerprint data, facial form data, hand form data, and individual DNA data. The scanner 12 (a) scans zones of a portable identification carrier 30 onto which is encoded identifying characteristic data of at least one person; (b) such identification data 15 is sent together with carrier data to the computer 26 for verification of authenticity of the carrier 30 and extraction of a identifying characteristic of a certain identifying characteristic parameter from the identifying characteristic data 15 encoded on the carrier 30. The identifying characteristic reader 14 reads a same identifying characteristic parameter of the person purported to be identified by the carrier 30. The comparator 20 compares the encoded identifying characteristic with the extracted identifying characteristic to authenticate the person associated with the carrier. The connections, if said carrier and at least one person are authenticated, enables the computer 16 to connect to a data storage device 32 of user permissions associated with that person or type of person. The disposition device dispositions the person or type of person. A disposition device may be a display device 24 connected to a record of dispositions associated, for example, with user permissions of the person or type of persons sought to be authenticated, the display device displaying any recorded dispositions to a user authority. The authority may then read the proposed dispositions.

With travel permission documents, the type of person is determined based on the nationality of the person, their wanted status or social responsibility.

Preferably, the encoded identifying characteristic data is encrypted prior to being encoded onto a data storage device in the carrier. The data storage device is a two dimensional graphical representation of the associated identifying characteristic readable by the scanner. The carrier is a printable substrate. The graphical representation is preferably printed on the substrate with security ink. The graphical representation is an hierarchical 2-D barcode in which data is represented by a two dimensional array of multi-nary or X-nary symbols. The barcode is “hierarchical” because, on one level, the Array has a meaning. It may be, for example, an encoded fingerprint of a person associated with the array. On another level, each digit of the array is a symbol that itself has a meaning—therefore, the hierarchy.

The symbols are referred to as being “X-nary” in the context of this application because the symbols described herein are not merely binary—rather they represent X-level bits in an X-level system. More aptly described, the symbols are X-nary where X is the number of meanings each symbol can have. For example, symbols in a binary system can only have two meanings: traditionally referred to as “on” or “off” but in the context of 2-D barcodes, “white” and “black”. Thus, a binary system is an X-nary system in which X=2.

In another example, in the decimal system, each bit can have up to ten meanings, i.e., numbers 0 to 9. For the sake of simplicity, we would refer to this system as “ten-nary”, an X-nary system in which X=10. Further, because these symbols have more than two meanings, a ten-nary system is multi-nary.

In a “multi-nary” system as defined in this application, the bit symbols occupying the digits of the matrix can carry more than a simple “white” or “black”, “1” or “0” meaning. Thus, as defined herein, a multi-nary system is comprised of a library of symbols representing at least three meanings.

The storage device stores personal data such as travel permissions in a secure manner. The travel permissions for example define the legal relationships between the persons, such as guardian, parent, etc. These permissions are preferably encrypted and encoded on a travel document or on a database, accessible automatically upon the presentation of a passport that is itself printed with an hierarchical 2-D barcode of encrypted identifying characteristic information. A function may be applied to the identifying characteristic data of interrelated persons to define a single graphical representation of these persons, including the associated permissions.

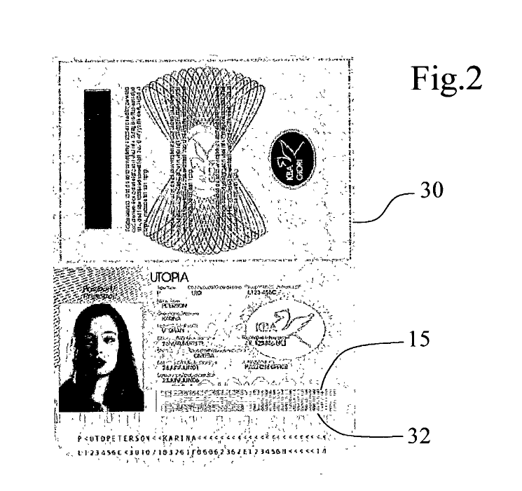

Referring now to FIG. 2, a machine-readable travel document is provided. The machine-readable document 30 is provided with an hierarchical 2-D barcode 15 in which an alphanumeric string is converted into a two dimensional hierarchical 2-D scannable barcode representation 32.

In its simplest form, this hierarchical barcode 15 would represent a binary system in which, as already mentioned, a black module or bit equals 1 and a white module or bit equals 0. This is a standard 2-D DataMatrix barcode such as developed by IDAutomation.com of Issaquah, Wash., USA. However, in a preferred embodiment, the symbol is a facsimile of a line, referred to hereinafter as a “digi-line”, in which the number of possible orientations of the digi-line defines the (X+1)-nary level of the system. For example, two orientations would represent a binary system in which, for example, a line at 0 deg equals 0, a line at 90 deg equals 1.

To make the barcode a four-nary code, it is only necessary to angle the lines at 0-45-90-135 degrees, thus representing 0, 1, 2, 3 respectively.

To create a eight-nary (octal), the angle of the lines can vary from 0, 22.5, 45, 67.5, 90, 112.5, 135, 157.5 to represent 0,1,2,3,4,5,6,7 respectively.

The 8 angles allow us to specify 8 values, or the equivalent of 3 binary bits each binary barcode occupies one of these bits, and the line angle to be used is determined by the combination of the binary layers.

The following formula is used to determine the binary equivalent data carrying capacity of the “digi-lines” of the invention:

Y=180/2^{(L)}

Where all digits have a line (i.e., the absence of a line is not permitted);

Y is the angular increment of the digi-line orientation;

L=number of equivalent binary layers

Thus, if the data carrying capacity of three binary levels is desired, then L=3 and the angular increment of 22.5 degrees is required.

The angular increment is important because it defines the readability of the barcode. A binary barcode is easiest to read because there is either something in the digit or there is not. As the barcode becomes more and more multi-nary, it becomes more and more difficult to distinguish between adjacent angular positions and therefore more difficult to scan with accuracy.

To go to a hierarchical barcode able to store the equivalent of four layers of binary information, we can divide the angle once again, decreasing the increment, or we can add some other indication such as a directional component (i.e. an arrow) in order to allow us to distinguish between 0 and 180 deg, 22.5 and 202.5, etc. In this case, the formula would be as follows:

Y=360/2^{(L)}

Thus, where an arrow or some other distinguishing characteristic is provided, the angular increment =360/8=22.5 degrees in order to gain the equivalent storage capacity of four binary layers. Thus, the resolution associated with adjacent positions of the digi-lines is not changed where an arrow is added and recognizable by the scanner.

Still further, inks with different spectral characteristics, i.e. visible only ink, infrared, uv, and white light, can be used to superimpose hierarchical barcodes. That is, for each ink, we add L-barcode layers where L is the number of layers used in the angular encoding outlined above. So, for example, if we are using a four layer hierarchical encoding then with 3 inks we can go to the storage capacity of 12 layers of binary barcodes.

The following is an example of multiple X-nary symbols which are combined by using different carriers:

X-nary symbol #1 is in visible black ink (IR and UV transparent)

X-nary symbol #2 is in an ink which is only visible when illuminated with UV light

X-nary symbol #3 is in an ink which is only visible when illuminated with IR light

Thus, three of the X-nary symbol barcodes would be combined to form a Multi-spectral X-nary symbol barcode.

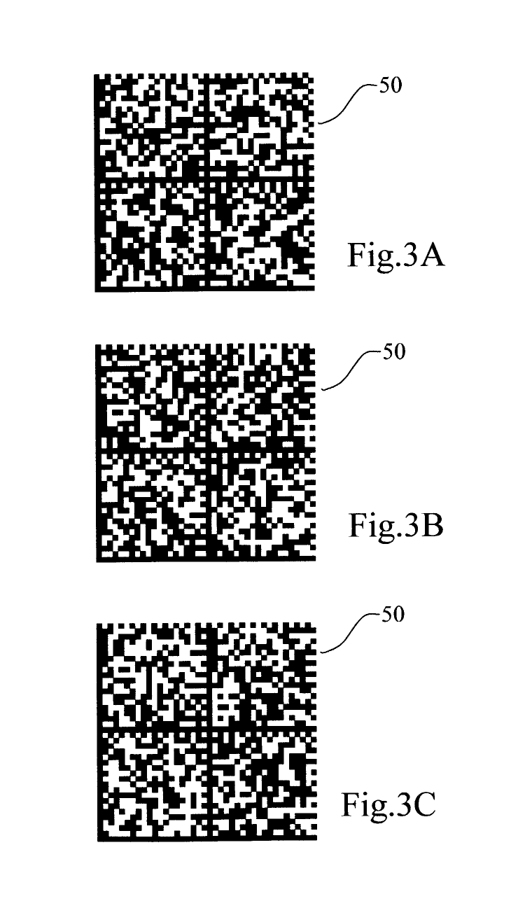

Referring now to FIGS. 3A-3C, plan views of three equivalent binary 2-D barcodes 50 of the prior art are shown.

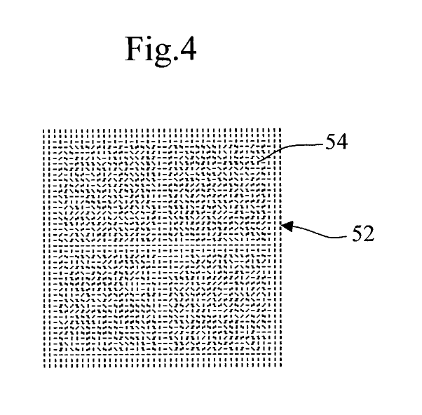

Referring now to FIG. 4, a schematic diagram of a hierarchical 2-D barcode 52 is provided, showing an array of digi-lines 54 each individually oriented at 0, 22.5, 45, 90, 112.5, 135, or 157.5 degrees, depending on what they each represent in the X-nary system. This hierarchical 2-D barcode 52 has a data carrying capacity comparable with that of all three binary 2-D barcodes 50 of FIGS. 3A to 3C.

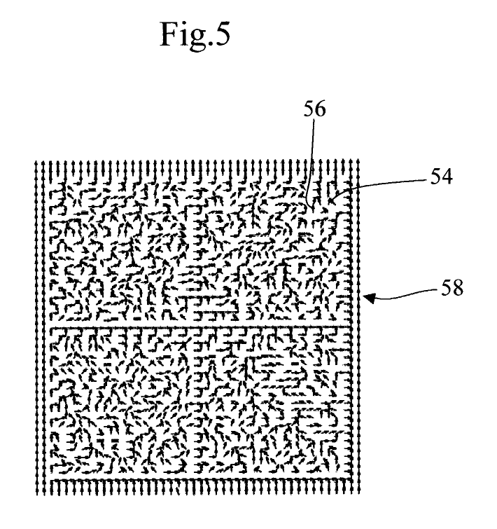

Referring now to FIG. 5, in another embodiment, a secondary characteristic is associated with each digi-line 54 of the barcode 52. The characteristic shown here is an arrow 56, adding a directional dimension to the hierarchical 2-D barcodes 58, thus increasing the X-nary X value by one as there is an additional identifying characteristic or digit.

In a preferred embodiment, the identifying characteristic data of two persons is encoded on an hierarchical 2-D barcode in black or of only a single primary color. This can be obtained by simple superposition of the encoded, encrypted bar code images wherein a known-to-the-decoder set of rules is applied to decode the hierarchical 2-D barcode of each individual This creates a unique barcode representative of the two individuals. Thus, where the common elements are identified on a parent or child's travel document, positive identification of each party and their relationship can be obtained.

Where a color hierarchical 2-D barcode is used, much more detailed identifying characteristic data (biometric, together with detailed personal information and permissions) may be encoded as a scanner reads more than 256 colors. Potentially, each digi-line can have any of 256 different values, greatly expanding the data-carrying capacity of an hierarchical 2-D barcode. Because of the added dimension of color, one can refer to color hierarchical 2-D barcodes as a sort of hierarchical 3-D barcode. Due to its high data carrying capacity, such color barcodes can be used as a 1-byte or 1 kbyte (or higher storage capacity) barcode and may be composed of any combination of colors.

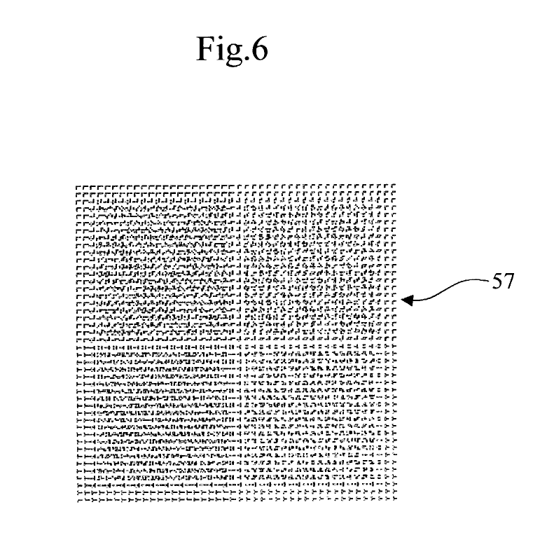

Referring now to FIG. 6, in another embodiment, a color hierarchical 2-D bar code 57 may be composed of a combinations of primary colors Cyan, Magenta, and Yellow. In such an embodiment in which each person is represented by a single barcode in a primary color, these discrete, single color barcodes can be combined and hierarchical 2-D to create the multi-color barcode 57 of FIG. 6, storing the identifying characteristic information of up to three persons.

In the case of multi-colored barcodes, the scanner 12 filters out each color of the barcode with the help of digital or optical filters in order to decompose the hierarchical 2-D barcode into 3 individual barcodes storing information on three or more individuals. It should be noted however that the combination of the three primary colors yields eight basic colors, plus one, no color (white), for a total 9. Thus, scanners sensitive to these colors can filter out information on up to nine persons. These colors may be in the visible spectrum or in the ultraviolet, or other spectrum invisible to the human eye. If in the invisible spectrum, the barcode can extend over already printed data in the visible spectrum. Such a storage medium may have significantly increased data capacity in a given space and at a given image resolution due to the fact that colors in the invisible spectrum can overlap an area printed in the open (i.e., an area printed in visible form on the carrier) with regular textual or photographic data.

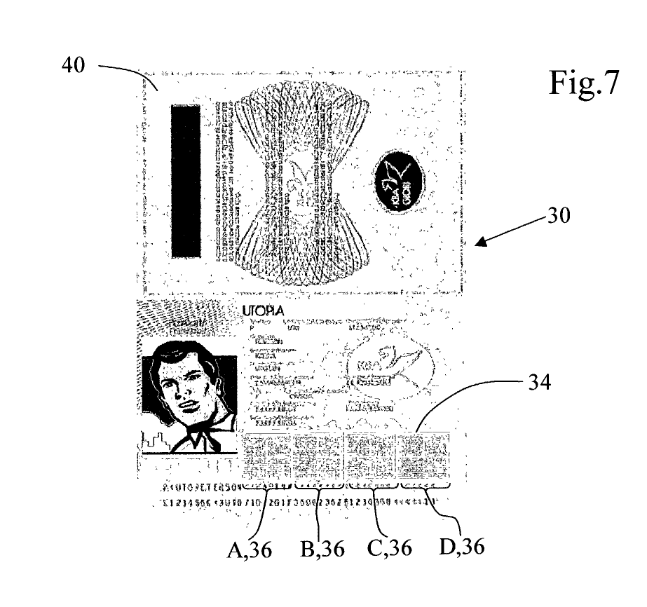

Referring now to FIG. 7 in another embodiment, a single barcode 44 is provided which is large enough and fine enough to store the identifying characteristic data of a family, including user permissions. Each barcode 34 on the user authorization is located in a specific field 36 of the identification substrate 40. A child barcode A is consistently located in field A. The child's travel permissions barcode B (giving or denying authorization for certain user permissions) is located below, in field B, a mother barcode (with permission information) is located in field C, above a father barcode D. Where these authorizations are placed according to a defined set of rules, there can be no confusion about who is who, about where to read the information and about the permissions given.

In another embodiment, the printed storage medium 30 includes several layers of information stored in discrete, hierarchical 2-D printing layers of information represented in an X-nary representation format (e.g., black and white hierarchical 2-D barcode representation), each layer storing information represented in a selected color. These colors may be in the visible spectrum or in the ultraviolet, or other spectrum invisible to the human eye. If in the invisible spectrum, the barcode can extend over already printed data in the visible spectrum. Such a storage medium has significantly increased data capacity in a given space and at a given image resolution.

It should be noted that superposition of hierarchical 2-D barcode data of different individuals preferably takes place digitally so as to create a single, multi-color layer to be printed or applied to the carrier 30. Although physically possible to apply each color layer to the card separately, this can cause register problems—digitally combining in a single multi-color layer overcomes these problems. This applies as well to an hierarchical 2-D barcode for application to the carrier 30 by any conventional method.

Any number of printing methods may be used. For example, thermo-transfer, die diffusion, offset digital, inkjet, photographic, bubble jet, letter press, topography, and laser printing and/or engraving may be used, provided that its characteristics are appropriate to efficiently printing variable information to a document.

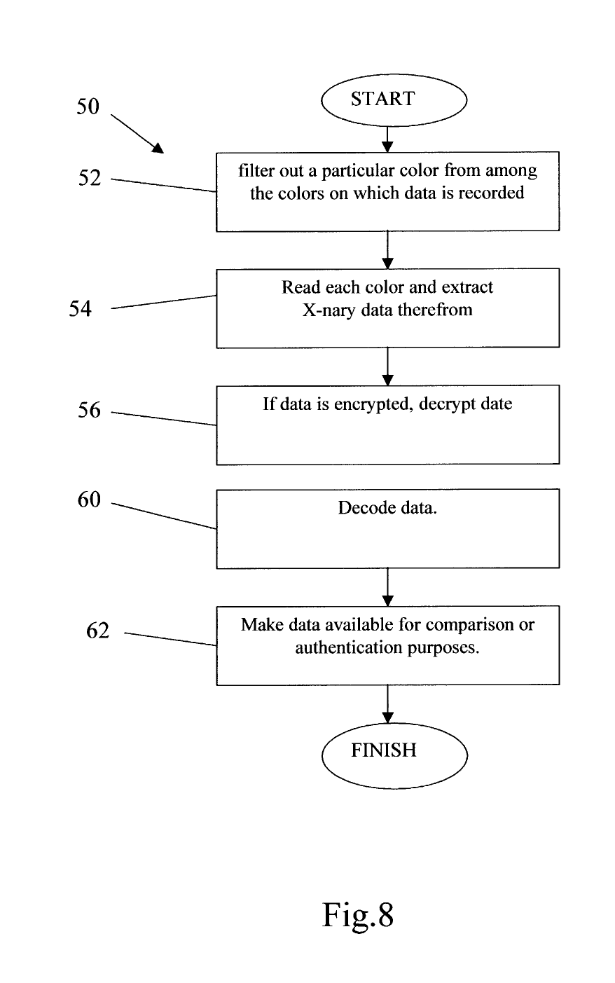

Now referring to FIG. 8, a decoding method 60 for the above-mentioned printed storage device is also provided. This decoding method 60 is made up of the following steps. In a first step 62, a digital or optical color filter (not shown) is used to filter out a particular color (whether visible or invisible) from among the colors on which data is recorded. In a second step 64, each color is then read and the X-nary data extracted therefrom. In a third step 66, if the data was encrypted, the encrypted X-nary data is decrypted. In a fourth step 70, the decrypted data is decoded. In a fifth step 72, the decoded data is made available for comparison or authentication purposes. Thus, the method 60 permits the reading of information by first separating the different layers of information through the use of a digital or optical color filter, followed by the decoding of the X-nary information of every individual layer.

The method of the invention converts encrypted identifying characteristic information into machine-readable hierarchical 2-D barcodes imprinted on a substrate referred to herein as a travel document. A high-density hierarchical 2-D barcode (including so-called “hierarchical 3-D” barcodes) have many benefits in this application. They are machine-readable. Barcoded information can first be encrypted, thus enhancing security. Further, a surface area of 18.35 mm×80.0 mm can hold more than 1.5 Kbytes (depending on the resolution and the scanner sensitivity used) of information, enough to hold a wide range of identifying characteristic data.

Encryption of the identifying characteristic data stored in a bar code ensures that personal, indelible data does not become known outside of a secure, controlled environment. Counterfeiting therefore becomes virtually impossible. Encryption may be carried out using the Public Key Infrastructure, a proven method of secure data transmission.

In addition, by virtue of the increased data capacity, other variable, unique digital information related to the holder or the document can be encrypted and encoded in the machine-readable data storage device. Thus a security feature related to the content of the document can be implemented by verifying the consistency of the data between the encrypted and encoded data and the data printed in the open (e.g. photographic, demographic or document related information). The algorithms for comparing the encrypted information from the data storage device with that same information printed in the open may be implemented in the document reading device.

The invention can encode in 2D form various types of identifying characteristic information. The use of a biometric system such as iris recognition is highly recommended because of its reliability. Iris recognition devices suitable for integration with the invention are available from IRIDIAN TECHNOLOGIES of Moorestown, N.J. and Geneva, Switzerland.

Finger print recognition devices suitable for integration in the invention are also available. Guardware Systems Ltd. of Budapest, Hungary, provides a suitable device.

Any suitable encryption method can be applied to the system and method of the invention. For example, Public Key Infrastructure can be used (i.e., asymmetric encryption). Such an encryption method is used many times daily for secure payments in numerous paperless banking and Internet transactions.

Integral to the system of the invention is a portable identification carrier reading and decoding device that reads and decodes an encoded, encrypted identifying characteristic on a portable identification carrier. The device includes a scanner, a processor, and a comparator. The scanner reads the encrypted identifying characteristic and transmits the read data to the processor for processing. The processor decrypts the identifying characteristic and transmits the decrypted identifying characteristic on to the comparator. The comparator compares this data with identifying characteristic data of the same type read from a person purported to be associated with the carrier, in order to verify the person's identity.

Now again to FIG. 6, a primary color-coded identification carrier 30 has a 3D data zone 150 and open data 152. The identification carrier 30 is a printed security paper 154.

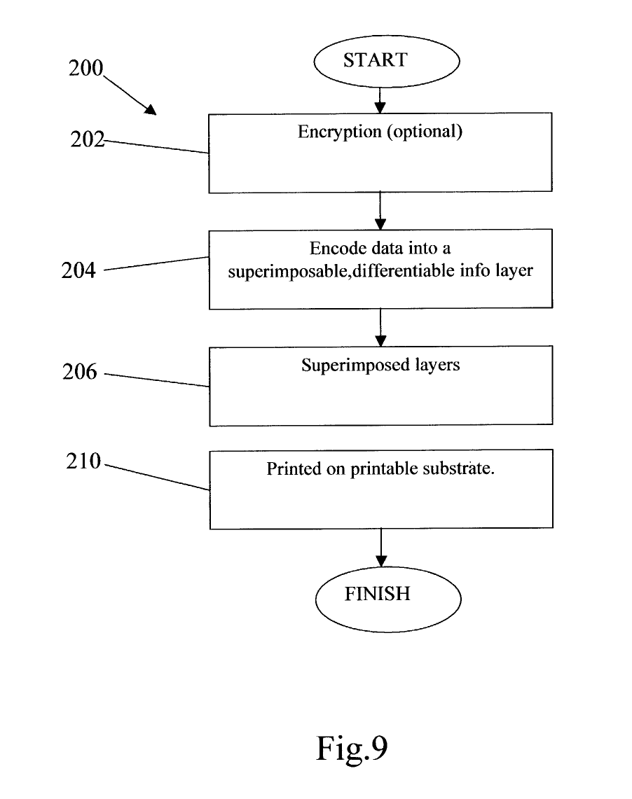

Referring now to FIG. 9, the method 200 of the invention increases the data storage capacity of a printed data storage device by implementing the following steps In a first step 202, data to be stored is optionally encrypted. In a second step 204, such information is encoded into a superimposable, differentiable information layer. Each layer of information is differentiated from other such layers through a specific characteristic in its representation in order to permit separation of the layers during a decoding process. In a third step 206, each differentiable layer of encoded information is superimposed over remaining layers. In a fifth step 210, the superimposed layers are printed on a printable substrate. The differentiation between layers may be obtained through a number of different means, including different color spectrums, light spectrums, or geometric modulation of information elements such as lines or symbols.

### EXAMPLES OF USE

Although the invention is useful in any industry (e.g., packaging, supermarkets, etc.), the invention is particularly applicable to improve control of the passage of individuals at a national border. Comparison of the traveler's identifying characteristic feature with decrypted and decoded information from the travel document ensures that the traveler is who he purports to be. This allows those individuals who have high quality characteristics (e.g., feature-comparison match, no exceptions recorded on the travel document or in the permissions database accessed remotely) to pass through the border without necessarily any personal physical interaction (e.g. self service border control processing). Only in the event of an exception, detected for example when the encoded information on the passport does not match read identifying characteristic information, need the border officials get involved, to confirm the determination of the method (this may be necessary due to the fact that identifying characteristics are not 100% reliable).

In another application, although visa documents (MRV) already allow for automatic reconciliation with the passport number using Optical Character Recognition (OCR), it is best to provide a field on the travel document for an optional barcode on MRV-A type documents (see ICAO document 9303 or corresponding ISO standard), so that consistent authentication using machine readable, encrypted identifying characteristic templates can be produced with the view to reduce Visa fraud.

In the airline industry, the system and method of the invention is useful to obviate the need for a separate boarding pass document. The passenger need only present his passport and submit himself to an identifying characteristic authentication (such as an iris scan, for example) to enter the airplane. Verification of the fact that one is a traveler could also be conducted at the check out of duty free shops, to ensure that the purchaser qualifies to make the purchase. Again, only if the system identifies exceptions is there a need for human intervention.

Again in the airline industry, luggage can be provided with ID tags having machine-readable identifying characteristic data of the owner thereon (optionally encrypted and encoded), to ensure that only the rightful owner of the luggage can leave the baggage claim area.

In the childcare industry, just as with luggage, children (whether recently born and still in the maternity ward or at a day care center) under the care of a guardian are provided with an encrypted, encoded identifying characteristic tag that matches the child's identifying characteristic information with that of the parent. The invention will therefore provide an identification function that will become more and more important as genetic engineering increases the number of genetically identical individuals. Fortunately, studies have shown that even identical twins have discernible iris and fingerprint patterns. In an alternate embodiment (not shown), the storage device is a remote database storing travel permissions in association with persons in a secure manner.

In an advantage of the invention, global interoperability between ID readers is provided through use of a printed document format similar to existing documents while adhering to existing document standards and reading technologies. This allows countries to individually upgrade their documents for the benefit of machine-readable identifying characteristic features at their time of choice, without compromising interoperability, as it exists today.

In another advantage, improved document security is provided through encryption.

In another advantage, positive identification and verification that the presenter of the document is the person associated with the document is provided, through the use of reliable identifying characteristic information, such as fingerprint and/or iris recognition biometric systems.

In another advantage, the invention is applicable for passports, visas, general Ids, driver's licenses, and other licensing documents.

In another advantage, the invention is low cost.

In another advantage, the handling of passengers at international borders can be automatic, the intervention of an individual being needed only in the event of an exception.

In another advantage, the method and system of the invention can be used to deter child trafficking by including a identifying characteristic template of children into their parent's travel document and vice versa, to ensure that a child cannot be freely transported across national borders without proper identification.

In another advantage, the system and method of the invention permits dynamic access to information such as wanted fugitive information, permitting a local database to be instantaneously updated with wanted information even shortly after the violation for which the fugitive is sought.

Multiple variations and modifications are possible in the embodiments of the invention described here. Although certain illustrative embodiments of the invention have been shown and described here, a wide range of modifications, changes, and substitutions is contemplated in the foregoing disclosure. In some instances, some features of the present invention may be employed without a corresponding use of the other features. Accordingly, it is appropriate that the foregoing description be construed broadly and understood as being given by way of illustration and example only, the spirit and scope of the invention being limited only by the appended claims.

What is claimed is:

1. A data storage device in which encoded machine-readable, digital data may be stored, the data being represented as X-nary data in a 2-D matrix, wherein the X-nary data is represented by an X-nary bit comprising a line wherein a characteristic angular displacement from a reference determines the value of the X-nary bit.

2. The device of claim 1 wherein the lins carries further data carrying characteristics.

3. The device of claim 2 wherein a data carrying characteristic is a direction indication.

4. The device of claim 3, wherein the direction indication is an arrow.

5. The device of claim 4, wherein an angular spacing between adjacent digits necessary to enable storage of a comparable amount of data as that of a matrix of binary bits is equal to the ratio 180/(2 to the power of the number of matrices of binary bits).

6. A user permissions communication interface system comprising a scanner, a identifying characteristic reader, a computer, a comparator, a connection means, and a disposition device,
wherein the connection means operably connects the computer to the scanner, the reader and disposition device,
wherein the scanner reads a portable identification carrier on which is encoded machine-readable, digital identifying characteristic data of at least one person, the data being represented as X-nary data in a 2-D matrix, wherein the X-nary data is represented by an X-nary bit comprising a line wherein a characteristic angular displacement from a reference determines the value of the X-nary bit wherein further the computer has:
(a) transmission means to transmit such scanned identifying characteristic data from the scanner to the computer for verification of the authenticity of the carrier, and
(b) logical extraction means to extract an identifying characteristic of a certain identifying characteristic parameter from the identifying characteristic data encoded on the carrier,
wherein the identifying characteristic reader is adapted to read a same identifying characteristic parameter of the at least one person purported to be identified by the carrier,
wherein the comparator compares the encoded identifying characteristic with the extracted identifying characteristic to authenticate the at least one person associated with the carrier; wherein the connection means, if the carrier and at least one person are authenticated, enables the computer to connect to a data storage device of permissions associated with that person or type of person; and
wherein the disposition device dispositions the at least one person in a prescribed manner.

7. The user permissions interface device of claim 6, wherein each barcode is each represented in a different color from either the visible or invisible part of the spectrum.

8. The system of claim 6, wherein the identifying characteristic reader is chosen from a group of identifying characteristic readers consisting of biometric readers, license readers, travel authorization readers, and custody document readers.

9. The system of claim 6, wherein the type of person is determined based on the nationality of the person.

10. The system of claim 6, wherein the encoded identifying characteristic data is encrypted prior to being encoded onto the carrier.

11. The system of claim 6, wherein the data storage device is integrated into the carrier.

12. The system of claim 11, wherein the data storage device is a printed graphical representation of the associated identifying characteristic readable by the scanner.

13. The system of claim 12, wherein the carrier is a printable substrate.

14. The system of claim 13, wherein the substrate is printed with security ink.

15. The system of claim 12, wherein the graphical representation is of an encrypted identifying characteristic.

16. The system of claim 6, wherein the storage device is a remote database storing permissions in association with persons in a secure manner.

17. The system of claim 6, wherein part of or all of the variable information on the identification carrier is encoded and encrypted in a data storage device on the same carrier.

18. The system of claim 6, wherein identifying characteristic data of at least two persons of which at least one has a legal responsibility for the other, are encoded on the carrier.

19. The system of claim 18, wherein a function is applied to the identifying characteristic data of the at least two persons to define a combined graphical representation of the at least two persons.

20. The system of claim 6, wherein the hierarchical 2-D barcode comprises combinations of primary colors cyan, magenta, and yellow.

21. The system of claim 20, wherein the hierarchical 2-D barcode is multi-colored and thus capable of storing the data of a number of persons corresponding to the number of colors in the barcode.

22. The system of claim 21 wherein the identifying characteristic data of each of the at least two persons is encoded on the hierarchical 2-D barcode of only a single primary color.

23. The system of claim 22, wherein the combined graphical representation is comprised of the superposition of the hierarchical 2-D barcodes of at most three individuals.

24. The system of claim 6, wherein the accessed permissions of the at least two persons relate to responsibilities of one person with respect to another.

25. The system of claim 6, wherein the identifying characteristic data is selected from one of a group of identifying characteristic data consisting of iris scan data, retina scan data, fingerprint data, facial form data, hand form data, and individual DNA data.

26. The system of claim 6, wherein the permissions may be printed by a method selected from one of a group of methods consisting of offset digital, inkjet, bubble jet, laser printing and laser etching.

27. An enhanced data storage device for machine-readable, digital data, for use in a portable identification carrier having at least one application surface onto which at least one layer is applied, the layer comprising encoded X-nary machine-readable, digital identifying characteristic data of at least one person, the data of each person being represented in a different barcode in the at least one layer, each barcode being an hierarchical 2-D barcode in which data is represented in a 2-D matrix, wherein the X-nary data is represented by an X-nary bit comprising a line wherein a characteristic angular displacement from a reference determines the value of the X-nary bit.

28. The device of claim 27, wherein the angular offset is equal to the ratio 180/(number of barcodes to be hierarchical 2-D).

29. The device of claim 27, wherein the encoded identifying characteristic data is encrypted prior to being encoded onto the carrier.

30. The device of claim 27, wherein the data storage device is integrated in the carrier.

31. The device of claim 30, wherein the data storage device is a printed graphical representation of the associated identifying characteristic readable by the scanner.

32. The device of claim 31, wherein the carrier is a printable substrate.

33. The device of claim 32, wherein the substrate is printed with security ink.

34. The device of claim 31, wherein the graphical representation is of an encrypted identifying characteristic.

35. The device of claim 31, wherein the graphical representation is an hierarchical 2-D barcode.

36. The device of claim 27, wherein the storage device is a remote database storing permissions in association with persons in a secure manner.

37. The device of claim 27, wherein part of or all of the variable information on the identification carrier is encoded and encrypted in a digital storage device on the same carrier.

38. The device of claim 27, wherein identifying characteristic data of at least two persons of which at least one has a legal responsibility for the other, is encoded on the carrier.

39. The device of claim 27, wherein a function is applied to the identifying characteristic data of the at least two persons to define a single graphical representation of the at least two persons.

40. The device of claim 39, wherein the graphical representation is an hierarchical 2-D barcode.

41. The device of claim 40, wherein the two dimensional bar code is comprised of combinations of primary colors cyan, magenta, and yellow.

42. The device of claim 40, wherein the two dimensional bar code is multi-colored and thus capable of storing the data of a number of persons corresponding to the number of colors in the bar code.

43. The device of claim 39 wherein the identifying characteristic data of each of the at least two persons is encoded on an hierarchical 2-D barcode of only a single primary color.

44. The device of claim 41, wherein the combination is comprised of the superposition of the 2D, primary color barcodes of at most three individuals.

45. The device of claim 36, wherein the accessed permissions of the at least two persons relate to responsibilities of one person with respect to another.

46. The system of claim 27 wherein the identifying characteristic data is selected from one of a group of identifying characteristic data consisting of iris scan data, retina scan data, fingerprint data, facial form data, hand form data, and individual DNA data.

47. The device of claim 36, wherein the permissions may be printed by a method selected from one of a group of methods consisting of offset digital, inkjet, bubble jet, laser printing, laser machining, and laser etching.

48. The device of claim 27 wherein the color is selected from either the visible or invisible part of the spectrum.

49. The device of claim 28 wherein any invisible layer extends over portions of the application surface of the carrier which may be printed with visible, non-encoded identifying characteristic data such as a digital photograph.

50. The data storage device of claim 27 wherein at least two persons are defined in a corresponding number of layers and hierarchical 2-D digitally to create a single multicolor image which is applied to a substrate.

51. An identification carrier reading and decoding device which reads and decodes an X-nary 2-D matrix encoded, encrypted identifying characteristic on a portable identification carrier, the device including a scanner, a processor, and a comparator, wherein the scanner reads the encrypted identifying characteristic and transmits the read data to the processor for processing, the processor decrypts the identifying characteristic and transmits the decrypted identifying characteristic on to the comparator, and the comparator compares this data with identifying characteristic data of the same type read by an identification characteristic reader from a person purported to be associated with the carrier, in order to verify the person's identity and subsequently, if identity is verified, to permit access to corresponding permission data.

52. The device of claim 51, wherein the identifying characteristic reader is chosen from a group of identifying characteristic readers consisting of biometric readers, license readers, travel authorization readers, and custody document readers.

53. A method of increasing the data storage capacity of a printed data storage device, the method comprising the steps of:
a. optionally encrypting data to be stored;
b. encoding such data into a superimposable, differentiable information layer, each layer of information being differentiated from other such layers through a specific characteristic in its representation, the differentiation permitting separation of the layers during a decoding process;
c. superposing each differentiable layers of encoded data; and
d. printing the superimposed layers on a printable substrate.

54. The method of claim 53 wherein such specific representations are selected from a group of representation types consisting of a color spectru datam, light spectrum, and geometry.
